(19) United States
(12) Patent Application Publication
(10) Pub. No.: US 2021/0049432 A1
(43) Pub. Date: Feb. 18, 2021

(54) Method and system for item marking and identification

(71) Applicant: Jaroslav Hook, Melbourne, FL (US)

(72) Inventor: Jaroslav Hook, Melbourne, FL (US)

(21) Appl. No.: 16/543,586

(22) Filed: Aug. 18, 2019

(51) Int. Cl. G06K 19/06; G06K 7/12

(52) U.S. Cl. CPC G06K 19/0614; G06K 7/12; G06K 19/06112; G06K 19/06028

(57) ABSTRACT

A method and system for item marking and identification, representing an alternative to bar code reading, based on a a time-varying post emission of a plurality of fluorescent/phosphorescent items embedded into a marker embodiments of the present invention thus providing optical markers for information exchange. In a typical embodiment, information to be transmitted is divided into packets, whereas each packet represents a unique wavelength spectrum or signature. The said emission signature is generated in packets as a response to an activation signal is then analyzed sequentially. The varying spectral content of each said packet encodes a symbol, while symbol's position is encoded with the timing of the after-emission packet.

### REFERENCES CITED

The below references are incorporated by the reference herein in their entirety and relied upon.

U.S. PATENT DOCUMENTS

| | | | |
|---|---|---|---|
| US 8,249,350 | B2 | Aug 21, 2012 | Svyatoslav Voloshynovskyy |
| | | | et al. |
| US 8,542,871 | B2 | Sep 24, 2013 | Svyatoslav Voloshynovskyy |
| | | | et al. |
| US 8,705,873 | B2 | Apr 22, 2014 | Svyatoslav Voloshynovskyy |
| | | | et al. |
| US 8,034,398 B2, 2011 | A | Jun 6, 2002 | Gary Ross, |
| US 8,287,993 B2, 2012 | A | Jun 6, 2002 | Xio-Dong, Fremont, CA |
| US 2,612,994 B2, 1952 | A | October 1952 | Norman J. Woodlandet al., |
| | | | Philadelphia, Pa. |

### RELATED US PATENT APPLICATIONS

Application U.S. Ser. No. 15/847,912 2017 Jaroslav Hook

Application U.S. Ser. No. 15/924,269 2018 Jaroslav Hook

### OTHER PUBLICATIONS

[1] Peiwei Gong, Jinqing Wang, Weiming Sun et al. Tunable photoluminescence and spectrum split from fluorinated to hydroxylated graphene

[2] Erin Hendrick, Margaret Frey, Erik Herz, Ulrich Wiesner, Cellulose Acetate Fibers with Fluorescing Nanoparticles for Anti-counterfeiting and pH-sensing Applications, Journal of Engineered Fibers and Fabrics, Volume 5, Issue 1-2010

[3] Jamie Kern, Synthesis of a Unique Fluorescent Material to Print onto Medications for use in the Anti-Counterfeiting of Pharmaceuticals, an on-line publication

[4] Sokolov, S. Naik, Novel type of fluorescent silica Nanoparticles: towards ultra bright silica nanoparticles, Dept. of Physics, 8 Clarkson Ave., Clarkson University

[5] Anja Schulz Fluorescent Nanoparticles for Ion Sensing, Dissertation, vorgelegt dem Rat der Chemisch-Geowissenschaftlichen Fakult at der Friedrich-Schiller-Universit at Jena

[6] Ajeet Singh, Shalinee Jha, Garima Srivastava, Preeti Sarkar, Prerana Gogoi, Silver Nanoparticles As Fluorescent Probes: New Approach For Bioimaging, INTERNATIONAL JOURNAL OF SCIENTIFIC TECHNOLOGY RESEARCH VOLUME 2, ISSUE 11, November 2013

[7] Erin Sue Hendrick, Cellulose acetate fibers with fluorescent nanoparticles for anti-counterfeiting purposes, Thesis Presented to the Faculty of the Graduate School of Cornell University

[8] Bruce R. Rae, Keith R. Muir, Zheng Gong, Jonathan McKendry, John M. Girkin, Erdan Gu, David Renshaw, Martin D. Dawson and Robert K. Henderson, A CMOS Time-Resolved Fluorescence Lifetime Analysis Micro-System, Sensors 2009, 9, 9255-9274

[9] Chenming Xue, Yuhua Xue, Liming Dai, Augustine Urbas, and Quan Li. Size-and Shape-Dependent Fluorescence Quenching of Gold Nanoparticles on Perylene Dye, Adv. Optical Mater. 2013

[10] A company publication An Introduction to Fluorescence Spectroscopy, 2000 PerkinElmer, Inc.

[11] Jobin Yyvon, Measuring Silica Nanoparticles via Fluorescence Anisotropy, Technical Note FL-25.

[12] Jobin Yvon Inc. Time-Gated Separation of Lanthanide Luminescence, SPEX Fluorescence Group publication

[13] Wenguan Zhang, Lian Qin, Shengmin Zhao, Red fluorescent Organic Nanoparticles Based on Donor-Acceptor Naphthylamino Fumaronitrile, Proceedings of the 17th IAPRI World Conference on Packaging

[14] Silver Nanoparticles As Fluorescent Probes: New Approach for Bio-imaging by Ajeet Singh, Shalinee Jha, Garima Srivastava, Preeti Sarkar, Prerana Gogoi

[15] From Size- and Shape-Dependent Fluorescence Quenching of Gold Nanoparticles on Perylene Dye by Chenming Xue, Yuhua Xue et al. at wileyonlinelibrary.com

[16] Fluorescence Hyperspectral Imaging Counterfeit Currency Detection and Analysis, by Horiba Scientific

[17] Tunable photoluminescence and spectrum split from fluorinated to hydroxylated graphene by P. Gong, J. Wang et al. we

[18] Invitrogen publication technical resource Guide for Fluorescence Polarization

[19] Fluorescent Nanoparticles for Ion Sensing Erlangung, Ph.D. Dissertation,

[20] Fuzzy Vault for Fingerprints, Umut Uludag, Sharath Pankanti, and Anil K. Jain

### OTHER PUBLICATIONS

Foreign Patent Documents:

[9] EP 2 221 020 B1 A2 Jun. 8, 2014 Marczyk, Stanislaw

### BRIEF DESCRIPTION OF THE DRAWINGS

The accompanying drawings, which are incorporated in and constitute a part of the present specification, illustrate embodiments of this disclosure. Along with an invention summary of the disclosure given above, and the detailed description of the embodiments given below, the said drawings serve to explain the principles of the disclosure.

Features and advantages of the invention will be obvious from the detailed description which follows, taken in conjunction with the accompanying illustrations, which together illustrate, by way of example, features of the invention; and, wherein:

FIG. 1. is an illustration demonstrating the principle of symbol encoding into a fluorescent tag accordance with the principles of the present disclosure. 1 depicts the activator; 2 depicts an example of a spectral distribution of the post emission corresponding to a symbol whereas the color represents a wavelength position within a spectrum and the height represents a relative power of that wavelength; 3 depicts a step function indicating a presence of the said after emission; 4 depicts an enlarged view of a possible embodiment of the fluorescent tag; 5 depicts a symbolic representation of an example of fluorescent entities; 6 depicts an example of symbolic sequence; encoded by the after emission of the said entities (5) with spectra (2) appearing in the time slots of (3).

FIG. 2.0 is an illustration of an example of encoding of symbols and the respective positions of the said symbols with the after emission spectral distribution and the respective time slots.

FIG. 3 (prior art U.S. patent application A Ser. No. 15/924,269) is a cross-sectional view of item's Fluorescent Marker (“Cavity” embodiment) in accordance with the principles of the present disclosure; (7) depicts a surface of the said item, wherein the said Marker is embedded in. (8) depicts a number of the fluorescent entities enclosed in the translucent solid medium (TSM) (9) wherein the said TSM is built in the aid item, (10) is a portion of TSM preventing the “falling out” off the item, (11) is a reflective surface.

FIG. 4 (prior art U.S. patent application A Ser. No. 15/924,269) is a cross-sectional view the item's Fluorescent Marker product (Tape embodiment) in accordance with the principles of the present disclosure; (12) depicts a surface of the said item, wherein the said Marker is embedded in. (14) depicts a number of the fluorescent entities enclosed in the translucent solid medium (TSM) (13) wherein the said TSM is built in the aid item, (15) is a “sticky” portion of TSM preventing the “falling out” off the item.

FIG. 5 (prior art U.S. patent application A Ser. No. 15/924,269) depicts front and side views of one possible embodiment of t he Activator used to invoke an after emission response from the Fluorescent Marker of FIG. 3,4. (16) illustrates the front view of the said Activator, 17 is a frontal and side views of a “white light” light emitting element, (18) and (19) are color and polarizing filters respectively. (20)

FIG. 6a, FIG. 6b. show block diagrams of two possible embodiments a structure of the Fluorescent Marker Reader. 21(a,b) illustrates an Activator, 22(a,b) is a Computational Unit, 23(a,b), 24(a,b) illustrate Visualization Screen (Display), 25(a,b) illustrates the storage. 26(a,b) illustrates the two possible embodiments of a fluorescent marker, 27 illustrates a mobile phone which may be used as a base platform for the said Fluorescent Marker Reader.

Reference will now be made to the exemplary embodiments shown, specific wording will be used herein to illustrate the same. Nevertheless, it will be understood that no limitation of the scope of the invention is thereby intended.

### OBJECTS OF THE INVENTION

The object of the present invention is a method, and process for is an optical, machine-readable, representation of data; where the said data usually describes something about the object that carries the said pattern.

### BACKGROUND OF THE INVENTION

This invention relates to the art of item marking and identification and has specific relevance to identification via the medium of machine readable identifying pattern. The principle goal of the present invention to provide a method and apparatus for classification physical items according to optical fluorescent response to an activation illumination of the special fluorescent markers (code) which constitute the information and which have been attached to, imprinted upon, built into, or caused to represent the items being identified.

Machine readable optical patterns placed on physical objects (items) can be used to represent digital data with further purpose of identification, inventory, tracing of the said items. For example, a one-dimensional bar codes have been used on external product packaging to identify a type of the product by a digital identifier. However, these bar codes require an area on the packaging dedicated to provide the digital identifier. In addition, the bar codes are typically not aesthetically pleasing to a human observer.

At the moment, most of the product items on the market, many documents are labeled with some kind of a 1D or 2D bar code, generally a following of either the EAN or the UPC standards or could be. The success of bar code based tags for these purposes as item identification, item tracking, and inventory handling could be explained by bar code's facilities to store, encode data in a compact manner with a small cost. The disclosed invention is an improved alternative to the bar code technology and serves the same purpose as the bar codes.

Prior art Bar code reading which utilities specially designed scanners is a fairly mature technology, developed from laser scanners reading 1 D bar codes to image based scanners for reading 2D bar code readers. Off the shelf commercial available laser-based or camera based hand-held bar code scanners are capable of achieving robust data extraction with an acceptable cost. Recently, a growing interest took place in extracting data from bar codes utilizing regular mobile phones, without utilization of a specially designed device. As a matter of fact, a variety of mobile installed software applications (apps) have bar code based access control to the complete characteristics of and user reviews for a product available at a store.

Nevertheless, the images extracted by mobile device cameras are not always of a quality sufficient for the bar code. Many such cameras on the market have produce blurred images. Very few mobile phones have a flash which increases the problem of the motion blur and sensor noise. All of the above factors, including low image quality, make bar code reading problematic under in certain circumstances. Moreover, all available camera-based bar code readers have poor performance under difficult light conditions, or at larger distances. In order to mitigate this issue, bar code reading software normally request the user to precisely direct the camera straight onto the bar code which taxes the users.

This invention presents a completely new technique which is an alternative to bar code reading, which advances the art and overcoming many of the mentioned issues and disadvantages inherent to bar code based technology.

A Fluocode (FC) is a dynamic, optical machine-readable representation (image) of data. The fluorescent response is read from the marker are read by spectral dynamic in response after illumination of a light source. Fluocode readers (FCR) could be made relatively inexpensive, the control software is easy to implement. It can be made more reliable and work on higher distances and more noise resistance than bar codes.

From Fluorescent Nanoparticles for Ion Sensing Erlangung, Ph.D. Dissertation, it is known that phosphorescent materials generally have much longer after-emission lifetimes than one for a typical fluorescent process due to a different role of electron's spin. As it turns out fluorescent spin causes energy transition process to occur with faster emission rates and hence, it results in much shorter fluorescence lifetimes in the range of a few nanosecond as compared with milliseconds and above for phosphorescence which is a special case of fluorescence.

The named post emission properties of some materials make them fluorescent or phosphorescent which is directly relevant to the object of this invention. The time characteristics of the phosphorescent post emission are especially important since their values are large enough so that they can be reliably measured using readily available devices, such as a cell phone camera and could be modulated by changing chemical composition of the entities

From Invitrogen publication technical resource Guide for Fluorescence Polarization we know that light emitted by many fluorescent materials may have different degree of polarization which depends on the incident polarization in a complex way, and chemical composition of the material. The estimate of the degree of polarization may be performed as a weighted mean of two light magnitudes filtered by perpendicularly oriented polarized filters.

From publication Tunable photoluminescence and spectrum split from fluorinated to hydroxylated graphene by P. Gong, J. Wang et al. we know that a graphene based fluorescent material hydroxylated graphene (HOG) made from fluorinated graphene exhibits a high degree of tunable emission with wavelength ranging from greenish white (343 . . . 392 nm) to deep blue (156 . . . 94 nm) nanometers. From the 3 aforementioned references we also can conclude that all these characteristics can be a basis of a particular embodiment of a dynamic fluorescent chaosmetric solution.

From Fluorescence Hyperspectral Imaging Counterfeit Currency Detection and Analysis, by Horiba Scientific we know that: fluorescent emission spectrum depends on the chemical additions and could be tuned by changing the chemical composition of the fluorescent compound. Hence such fluorescence properties as emission and absorption spectra, polarization and time delay and time decay characteristics may be tunable and highly variable. Fluorescent logo proposed described in patent application U.S. Pat. No. 0,270,457, 2013 distinguishes a bona fide product from a counterfeit one. Such a high variability also allows chaosmetric solutions.

From US 2003/0003323 A1 it is known that it is not necessary on practice (Stokes Law) to have UV rays as activation source for the fluorescence as long as the activation/absorption source has a shorter wavelength than the emitted spectrum. Moreover, the activation wavelengths may even be infrared if emitted spectrum has still a larger wavelength. Hence such infrared emitting particles with infrared activation may also be used in for anti-counterfeiting of the special document paper.

A special family of the counterfeiting optical taggants are the ones based on the effect known in non linear optics: From the aforementioned dissertation we also know that the fluorescence is a non linear optical effect which is an longer wavelength light emission after being exposed to light of a shorter wavelength. A taggant containing entities of fluorescent materials, may be embedded in a product item in a way, which may not even be observable by human eye, unless it is activated by ultraviolet illumination. The technical difficulties of manufacturing of such a taggant may often prove to be insurmountable for a counterfeiters so feature serve as a brand protection feature.

From U.S. Pat. No. 7,289,205 B2 a method is known how fluorescence polarization imaging devices and methods, polarization of the fluorescent emission could be measured efficiently and precisely.

From the publication Silver Nanoparticles As Fluorescent Probes: New Approach for Bio-imaging by Ajeet Singh, Shalinee Jha, Garima Srivastava, Preeti Sarkar, Prerana Gogoi it is known that silver nanoparticles possessing fluorescent properties could be created using chemical reduction of silver nitrate and characterized using NMR and FT-IR and could be injected into the human body for medical imaging. The use of such particles indicates the existence of fluorescent materials which are safe for humans, hence may be used for the medical products with other purposes for anti-counterfeiting of the pharmaceutical products.

From Size- and Shape-Dependent Fluorescence Quenching of Gold Nanoparticles on Perylene Dye by Chenming Xue, Yuhua Xue et al. at wileyonlinelibrary.com it is known that the gold nanoparticles have fluorescent properties in the range 600 nanometers and up.

From the U.S. patent application A Ser. No. 15/847,912 A, December 2017, A Ser. No. 15/924,269 March 2018 we know that a plurality of fluorescent/phosphorescent entities can be properly modulated to produce a unique signature.

From the U.S. Pat. No. 2,612,994 we know that item classifications could be assisted by applying labels with printed images of machine readable geometrical shapes, encoding an information pertinent to the said item.

The related Applications U.S. Ser. No. 15/847,912 discloses the method where spectral, polarization dynamic fluorescent signature is used to protect the item's genuineness. From this documents it is known that combined spectral, polarization dynamic properties

### SUMMARY OF THE INVENTION

In the following detailed description, numerous specific details are set forth in order to provide a thorough understanding of the invention. The foregoing and other problems are overcome, and other advantages are realized, in accordance with the presently preferred embodiments of the present invention. The present invention is an advancement over the prior art since their use eases the information storage to and reading from an item.

However, it may be understood by those skilled in the art that the present invention may be practiced Without these specific details. In other instances, Well-known methods, procedures, and components have not been described in detail so as not to obscure the present invention. The present invention is a stage and extraction of the visual information form an item, method that attempts to address these main problems, discussed in the Background.

This Summary is provided to introduce a selection of concepts in a simplified form that are further described below in the detailed description. Only a short overview of preferred embodiments is presented. This summary is aimed to facilitate the understanding of the technology but does not include the key or essential characteristics of the technology. This Summary is not intended to identify key features or essential features of the claimed subject matter, nor is it intended to be used as an aid in determining the scope of the claimed subject matter. Neither it aimed at limiting the scope of the claimed subject matter. Then particular technology embodiments are described in further detail later.

The present invention provides an alternative to bar code technology which does not have many problems inherent image based technology. Instead of the image search of the bar code and expensive image processing spectral analysis of the fluorescent “shining dots” is performed. It is also illustrated using this approach does not have such difficulties with a “busy” scenes where a bar code surrounded by had to trace artifacts, poor quality images,

Embodiments of the invention can be implemented as a computer-implemented technique with a number of computational steps to perform to at least some of the method stages of the invention. Embodiments of the invention can also be an activator of the fluorescent entities attachable to/controllable by a mobile device such as cell phone or otherwise.

Embodiments of the present invention can also be a fluorescent marker consisting of the plurality of the fluorescent entities embedded into the a transparent casing, which is in turn embedded into an item. It receiving the activation illumination message from the activator according to embodiments of the invention.

Embodiments of the invention can also be a system of an activator, camera (e.g. standard camera or any mobile device with a camera such as a smart phone), whereas the former and later are equipped with the polarized filters, with an application of function is a fluorescent marker reader system embodying at least some of the elements of the invention. It is noted that embodiments of the invention can be applied to any type of fluorescent tag and are not limited to a particular type. Furthermore, the invention could also be used for images other than fluorescent tag containing the fluorescent entities

This invention is a natural continuation of he application of U.S. application Ser. Nos. 15/847,912 and 15/924,269 on the using fluorescent effect and the markers with a purpose of counterfeit protection and identification respectively. This invention is, however going further and instead of a random combination of the spectral, polarization, dynamic characteristics is actually using the latter in order to encode a desired information and place it on an item in question, with a purpose of subsequent reading, similar to a bar code.

Therefore the major advantages of the proposed invention can be summarized as follows:

1) Due to the inherently better noise resistance of the spectral, polarization, temporal patterns, given physical nature fluorescence the pattern matching is more robust than the bar codes or color codes known to those skilled in prior art. The bar codes are printed and extracted as light intensity magnitudes, which is inherently less noise resistant than the said spectrum, polarization or temporal characteristics

2) Due to use of angle invariant spectral-polarization-temporal characteristics of the Fluorescent Code, their respective readers can operate at very blunt incidence angles (as little as 10 degrees to the surface plane) unlike bar codes readers which oftentimes require angles for their operations close to perpendicular (at least 60 degrees). This capacity facilitates and speeds up user's work.

3) Due to use of temporal dimension in spectral-polarization-temporal characteristics of the Fluorescent Code (FC), their respective Fluorescent Code Readers (FCR) can operate at larger distances than bar codes readers which require a certain spatial resolution thus limiting the range of the operations.

4) Due to the use of temporal spectral characteristics of the FMs, their respective FCRs can operate at busy and noisy scenes inherently better than bar codes readers. The later may have limited computational capacity and have to execute computationally intensive image processing algorithms to identify the said bar codes among such a busy scene.

6) Due to the use of temporal spectral characteristics of the FMs, their respective FMRs can operate at busy and noisy scenes inherently better than bar codes readers. The later may have limited computational capacity and have to execute computationally intensive image processing algorithms to identify the said bar codes among such a busy scene.

Further particular methods, approaches and structure of the process of the subject invention will become more apparent from the detailed description of the preferred embodiments together with the respective drawings.

### DETAILED DESCRIPTION OF THE PREFERRED EMBODIMENTS

The present invention provides process for counterfeit document protection. Other features and advantages of the invention will be obvious to those skilled in art from the detailed description foregoing accompanying drawings. Unless stated otherwise, all technical terms utilized herein have the same meaning as generally accepted by those skilled in the art. All references, applications for patent or granted patents or any other references used herein are included by list of reference in their entirety. Should a conflict arises, the present description, including definitions, will overrule. Moreover, the materials, techniques, and any examples are for illustration purpose only and not intended to be limiting.

In the present detailed description, a number of specific details is provided in order to facilitate a thorough understanding of the invention. Nevertheless, it may be understood by those skilled in the art that the said invention may be practiced without these specific details. In other cases, well-known or publicly available techniques, procedures, and components have not been described in a great level of detail so as not to obscure the present invention. The embodiment of the invention represents a method, and a product which addresses the main problems, discussed in the background: document authentication.

The present invention is aimed to create and read an item label physical principle different from the prior art which is based on bar codes. The said label will be further referred as Fluocode (FC). It is based on a on of diverse spectral-polarization temporal properties of the after emission fluorescent/phosphorescent response of Florescent Code, built in the item and serving as item's identity. For the purpose of brevity the term “fluorescent” will further signify both fluorescent and phosphorescent. A particular trait of the phosphoresce subset of the fluorescence effect is much larger delay times which enables its sampling by a sequence of the capture frames and further processing.

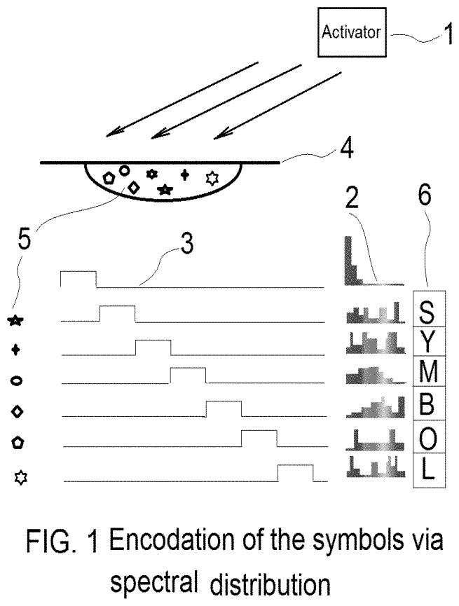

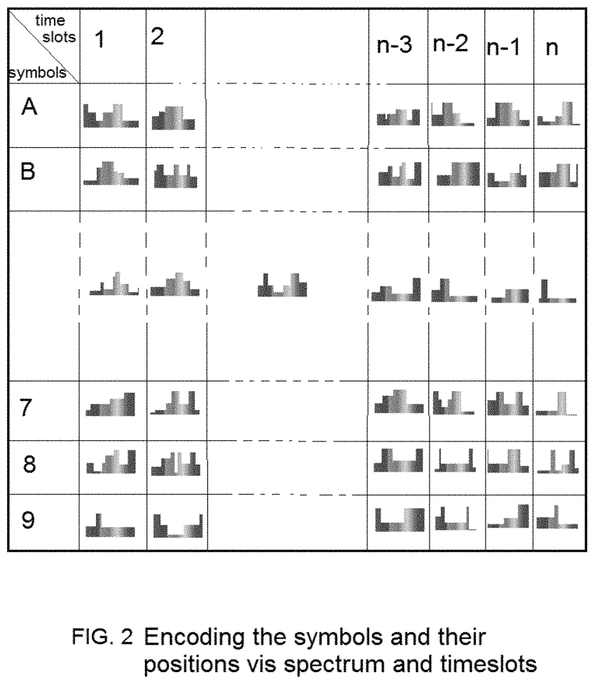

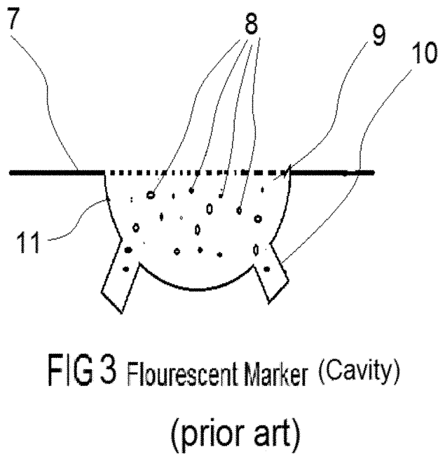

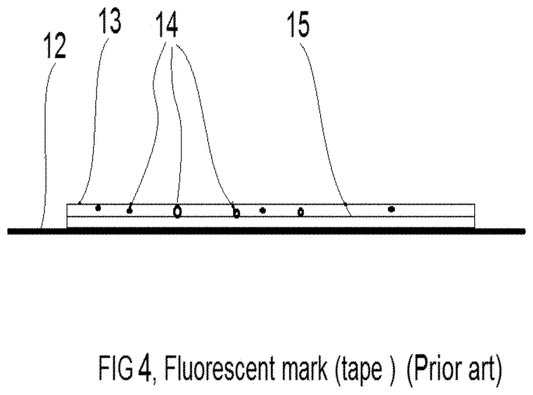

Understanding of the invention will be enhanced with FIG. 1, FIG. 2, FIG. 3, FIG. 4 which illustrate two possible alternative embodiments of the said Fluorescent Code (FC), each comprising Plurality of Fluorescent Entities (PDFE) (14 and 8) embedded in a said Transparent Solid Medium (TSM) (9,15) enclosed within the said Cavity (5) of FIG. 3 or in an alternative embodiment where in the said TSM represents a flat layer (15) ( ) shown FIG. 4. of a type “Tape”.

Understanding of the first embodiment of the said FC will be further enhanced with the aid of FIG. 1,2,3. The item's surface contains a Cavity (11) of an arbitrary shape also comprises at least two Outlets (10). The said Cavity (11) is located below the plane of the item's surface. The said Cavity (11) is filled in with the Transparent Solid Medium (TSM) (9). The said outlets (10) are shaped in order to keep the TSM firmly inside the said Cavity. The maximum size at the cross section of the said Cavity (11) is kept 5 mm or at most ¼ of the cross-section of the surrounding item's area, whichever is smaller. In a preferred embodiment shown on FIG. 3 the said TSM top's surface is aligned with the same of the said item. Furthermore the said TSM contains a collection of PDFE (5,8,14 of FIG. 3, FIG. 4 respectively). Each particle in the said collection is chosen in such a way that they all have the non-overlapping afterglow times and the respective spectral/polarization characteristics encode a symbol from the encoding table of the FIG. 2.

An example of how particular fluorescent properties of each of the said entities (8,14) are selected is presented on the FIG. 1 and FIG. 2. Given a symbolic sequence sequence “SYMBOL” may be encoded by selecting a particular combination of the fluorescent properties of the said PDFE (5). such an encoding a symbol location is encoded as a time delay corresponding to a time slot (3), and such fluorescent properties as spectrum distribution, (2) from the table shown on FIG. 2. The said FIG. 2 shows a table containing an example of how each symbol may be encoded for each given position. Given a position N within a symbolic string and the corresponding time slot N a symbol is encoded by a fluorescent entity possessing the time delay falling within the said tile time slot and the spectral characteristic from the table's column corresponding to the said time slot and the table's row corresponding to the symbol to be encoded. A particular chemical composition of a corresponding fluorescent particle and a method of application is chosen by someone skilled in the respective art. A particular material for TSM could be selected by those skilled in art of Optical materials. A particular method of “printing” may be chosen by someone skilled in art of printing devices.

In its second embodiment the said FC has a flat shape shown on FIG. 4, wherein the top surface of TSM does not elevate above the surface (12) of the said item more than 2 mm. It comprises a layer of TSM (13) with enclosures at least one fluorescent/phosphorescent Particle (FPP) wherein FPP forms PDFE (5, 8, 14). The said TSM (13) is attached to the item's surface by an adhesive material (15). Similarly each particle encodes exactly one symbol.

The said PDFE (5,8,14) comprises at least one individual Fluorescent/Phosphorescent Particle-oentity (FPP) of a maximum size of 0.1 mm. The critical physical properties of the said FPP are polarization degree, after emission spectrum, the associated time delay. The said after emission spectrum average of each said particle (FPP) is within 300 through 1000 nm with width of the spectral band of no more than 250 nanometers. The absorption spectrum is within he said spectral band minus 100 nm with the width no more than 200 nm. The associated time delays are chosen to be within the range from 0 to 100 milliseconds, mutually non-overlapping and each to correspond to the position of a symbol which a particular particle encodes.

Each of the said PDFEs located on a respective FC is activated by apparatus further refereed as Activator (16, 21a, 21b) or (10a of FIG. 4a) with structure of the preferred embodiment shown on FIG. 3, prior art of the application U.S. Ser. No. 15/924,269. The said Activator in this preferred embodiment comprises of at least one individual narrow spectrum sources (NSS) (17). Each of the said NSSs further comprises further contains an WSS (17) with their respective color filter (CF) (19) and polarization filters (PF) (18) where in the said filters sufficient to cover spectrum within the said range of 300 through 1000 and at least two maximally spread polarizations respectively. Its function is a controlled multi wavelength, multi polarized light source. Each of the said CF is transparent only in an effective spectrum of at most than 50 nanometers. Each of the said WSS are able to emit the light within a solid angle of at least 15 degrees. The said Activator (14) is configured to switch 16 of the said WSS (17) ON and OFF on a duration between 1 to 100 milliseconds. A particular control algorithm could be chosen so that the Table 2 becomes feasible.

With the said wavelength/polarization/duration control and coverage a properly controlled Activator (16) is able to generate a diverse controllable spectrum, polarization and duration distribution of the activation signal, with a programmed control producible by someone skilled in art. This diversity is highly desired for extraction of a fluorescent response from the said FC shown at FIG. 1, 3,4. [0050] Each of the said plurality of NSS are designed is to have a band wavelengths 100 nanometers wide at acceptance angle no more than 30 degrees. Such a design is executable by someone skilled in art. [0051] The use on an alternative embodiment of the said Activator is acceptable as long as it is capable to generate a light pulse of arbitrary duration, spectrum and polarization within the said requirements, if designed by someone skilled in art.

The use on an alternative embodiment of the said Activator is acceptable as long as it is capable to generate a light pulse of arbitrary duration, spectrum and polarization within the said requirements, if designed by someone skilled in art of optics and illumination.

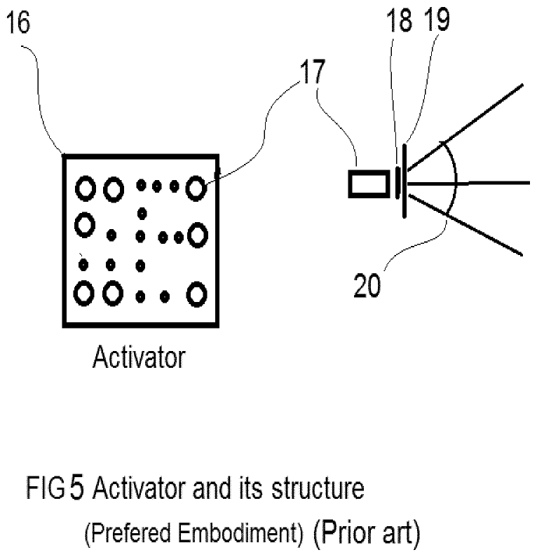

FIG. 1 shows an example of the said Activator's excitation and after emission response of said FC which encodes a symbolic sequence. This response is polarization temporal spectral characteristic, which is the key physical pattern forming the said FCâ\check{A}Źs uniqueness. Sampled and stored such a characteristic forms an After Emission Signature (AES) encodes at least one symbol from the table of FIG. 2.0, which further forms a symbol sequence used for further identification and matching. Only spectrum and the time delayed are illustrated with the polarization dimension not shown on the drawing, due to inherent limitations of 2D representation, but is assumed to be present as an additional dimension in a said AES. The said Activator (16, FIG. 5) generates an activation light signal of the spectral temporal shape samples (2), which in turns invokes an after emission response signal from the said FM of the spectral temporal shape samples (20). The uniqueness of the said after emission for an individual marker is due to an increased space of the respective individual Fluorescent/Phosphorescent Particles (FPPs) shown at FIG. 1,2,3 characteristics forming the PDFE, wherein the 17 said FPP is the active part of the marker thus giving an identity to an item wherein the said Fluorescent Code is embedded.

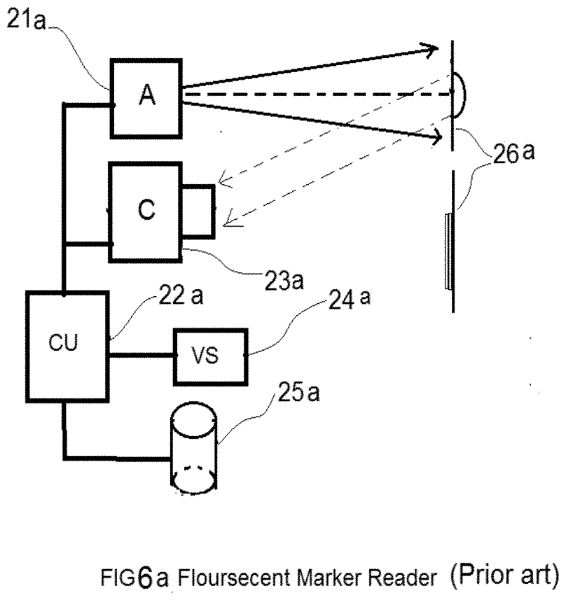

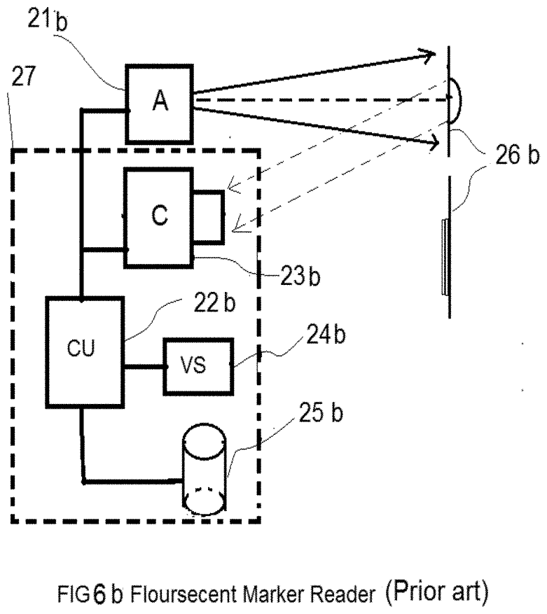

Understanding the invention will be further enhanced with the aid of FIG. 6a,b showing a schematic a block diagram of the Fluorescent Code Reader (FCR) apparatus. The said FCR used in the process of item identification and search on the scene. The said FCR further comprises of the said Activator (21a of FIG. 26a, the same as (21b) of FIG. 6b). The FCR also comprises Camera (23a,b), Computational Unit (22,a), Data Base (25, 6a), Visualization Screen (VS 24a),b)). The said CU (22a) is programmed to control the said Activator (21a) and the said VS used for visualization in order to to generate a activation sequence of a desired spectral temporal characteristics. The said Camera (23a,b) is controlled by the said CU 22a) in order to capture a response of the said Fluorescent Code Reader (FCR) in any its of three possible embodiments: Cavity, Tape,

The said color Camera (23a)b) is of a digital type, comprises at least 5 Megapixels and has at most 10 milliseconds per capture and reception spectrum of the range of at least 250 nm through 1200. The Computational Unit (CU, 23a, b), is a programmable computational device, with clock frequency of at least 1 GHz, and at least 10000 MIPS. The Data Base (25a) is an information storage, able to store at least 10 Megabytes. The said Camera, Computation Unit, Storage may be implemented by those skilled in art.

Other features and advantages of the invention will be evident to those skilled in the art ordinary skill from the detailed description as follows and accompanying schematic drawings. Unless otherwise determined, all technological terms utilized herein have the same meaning as generally accepted by those skilled in the pertaining art. All publications, patent applications, granted patents and other references referenced herein are included by reference list in their entirety. Should a conflict arises, the present description, including definitions, will control. In addition, the materials, techniques, and illustrating examples are for demonstration only and not intended to be limiting.

It should be obvious to those skilled in the art that different variations can be performed to the structure of the present invention without departing from the scope or general spirit of the present invention. In view of the foregoing, it is intended that the present invention cover modifications and variations of this invention provided they fall within the scope of the following claims, their equivalents or analogs.

What is claimed:

1. Process, system, method and product for item marking and identification and identification comprising Fluorescent Code wherein the said Fluorescent Code is integrated into a said item; Fluorescent Code Reader.

2. Process, system, method and product for item marking and identification, comprising Fluorescent Code of the claim 1 implemented as a marker of the said item and possessing optical after emission properties sufficient for on the said items identification.

3. Process, system for for item marking and identification having provided thereon optically characterized classifying markings on the articles comprising the Cavity embodiment of Fluorescent Code product of the claim 1 and claim 2 further comprising: Transparent Solid Medium which has a absorption spectrum at most 10 in the relevant wavelength band; Encoding Table with rows and columns to the response times and spectral signatures correspond to a symbol position and its its value respectively; Plurality of Dynamic Fluorescent Entities embedded in the said Transparent Solid Medium, wherein the said Plurality contains fluorescent entities with the non overlapping response times spread of at least of 1 nanosecond apart, where the after emission florescent spectra of the said entities with spectral width and the average wavelength of at least 50 nanometers, where in the said response times and the said spectra are taken from a raw and the column of the said Encoding Table; Cavity embedded in the item's surface, which the said Transparent Solid Medium fills in, where in the said PDFEs are distributed in randomly throughout the said cavity's space, wherein the said cavity's shape is sufficient to prevents its detachment from the said cavity item, and filled.

4. Process, method and system for item marking and identification of the claim 1 and claim 2 having provided thereon optically characterized classifying markings on the articles comprising document feature extraction and digitizing as in claim 3, Tape embodiment of Fluorescent Marker product of the claims 1 further comprising: Transparent Solid Medium as in claim 2, but in a shape of a layer at most 1 mm thick on a sticky tape applied on the item; Plurality of Dynamic Fluorescent Entities as in claim 2 placed inside of the said Transparent Solid Medium, wherein the said PDFE encodes a symbolic sequence via dynamic spectral polarization characteristics.

5. Process and product for item marking and identification comprising of Plurality of Dynamic Fluorescent Entities wherein each fluorescent entity via its dynamic fluorescent characteristics uniquely encodes at least one symbol value and its time slot according; Encoding Table which further comprises of the rows and columns wherein each entry corresponds to a unique combination of the delay time and spectral polarizing characteristics encoding the said symbol's time position and the value respectively.

6. Process and product for item marking and identification; Fluorescent Code Reader (FCR) apparatus of the claim 1 comprising Activator; Camera, further comprising at least one polarized filter and at least 2 megapixels of at least 3 types covering the spectral range of at least 400 through 1000 nm; Data base, able to store the responses of the Plurality of Fluorescent Entities of the claims 2,3,4, captured by the said Camera; Visualizing Screen able to display the scene; Computation Unit programmed to control the said Camera, Activator, Visualizing Screen; Controlling software installed on the said Computation Unit, able to control the said Camera, Activator, Visualizing Screen and perform converting a desired light pulse duration, spectral range and polarization into control signal of the said Activator, encoding, storage, matching the response of the said Fluorescent Marker for the purpose of identification and search on the scene methods of the claim 1.

7. Preferred embodiment of the Activator apparatus of the claim 6 comprises: at least one polarized filter of adjustable angle; at least of color filter; at least one light source able to generate a pulse of light of the length between 100 milliseconds and 1 millisecond, covering spectrum range at least between 300 through 1000 nm at total illumination levels power at 2000 through 200 lumens in spread between 15 through 30 degrees of solid angle.
